(19) United States
(12) Patent Application Publication
(10) Pub. No.: US 2006/0067280 A1
(43) Pub. Date: Mar. 30, 2006

(54) Wireless medium access control protocol with micro-scheduling

(76) Inventors: John S. Howard, Portland, OR (US); Charles L. Brabenac, Portland, OR (US)

Correspondence Address: SCHWEGMAN, LUNDBERG, WOESSNER & KLUTH, 1600 TCF TOWER, 121 SOUTH EIGHT STREET, MINNEAPOLIS, MN, 55402, US

(21) Appl. No.: 10/954,013

(22) Filed: Sep. 29, 2004

(51) Int. Cl. H04J 3/00

(52) U.S. Cl. 370/337; 370/442

(57) ABSTRACT

A micro-scheduling capability provides networks with the capability of dynamically managing time slots. Such time slots may be contained within a superframe that begins with a beacon transmitted by a node. One or more particular time slots are designated as micro-scheduled time allocations, the composition of which may be dynamically modified during the micro-scheduled time allocation.

### TECHNICAL FIELD

Various embodiments described herein relate to wireless communications generally and, more specifically, to managing communications among devices within a wireless network.

### BACKGROUND INFORMATION

Piconets, also referred to as wireless personal area networks (WPANs), are small-scale networks over which fixed and portable devices may communicate and transfer a variety of data types including multimedia files, such as video, digital images, and audio. Standards have been created that specify the medium access control (MAC) and physical layer for such networks, notably the Institute of Electrical and Electronics Engineers (IEEE) standard 802.15.3.

### BRIEF DESCRIPTION OF THE DRAWINGS

FIG. 1 illustrates a block diagram of a wireless personal area network (WPAN), in accordance with an embodiment of the inventive subject matter;

FIG. 2 illustrates a superframe and a child superframe, in accordance with an embodiment of the inventive subject matter;

FIG. 3 illustrates a micro-scheduling capability implemented in a superframe, in accordance with an embodiment of the inventive subject matter;

FIG. 4 is a block diagram of an article according to various embodiments of the inventive subject matter; and

FIGS. 5A and 5B together constitute a flow diagram illustrating several methods according to various embodiments of the inventive subject matter.

### DETAILED DESCRIPTION

In the following detailed description of embodiments of the inventive subject matter, reference is made to the accompanying drawings that form a part hereof, and in which are shown by way of illustration specific preferred embodiments in which the inventive subject matter may be practiced. These embodiments are described in sufficient detail to enable those skilled in the art to practice the inventive subject matter, and it is to be understood that other embodiments may be utilized and that structural, mechanical, compositional, electrical, and procedural changes may be made without departing from the spirit and scope of the inventive subject matter. The following detailed description is, therefore, not to be taken in a limiting sense, and the scope of the inventive subject matter is defined only by the appended claims.

Devices that implement IEEE 802.15.3 may connect in an ad hoc manner and may communicate by peer-to-peer networking, allowing them to self-organize and connect without user intervention. In order to ensure the reliable quality of service needed for multimedia applications, IEEE 802.15.3 employs a time-division multiple access (TDMA) communications protocol to allocate channel time among devices. Devices are assigned fixed time slots on a bandwidth-available basis. A “time slot” is defined herein to mean a time period during which a device in a network may communicate over a communications channel. In order to prevent contention conflicts among devices of a network, the devices are guaranteed access to the channel for communication purposes only during these fixed time slots.

Applicants are aware that some applications, such as those involving multimedia, may perform better if they are allocated channel access on a more flexible basis than a strict TDMA protocol in accordance with the IEEE 802.15.3 standard. Embodiments of the inventive subject matter provide this flexibility. Various embodiments are illustrated and described herein.

The methods, protocols, processor-readable media, and apparatus, including systems, devices, processors, and integrated circuits described herein relate to a medium access control (MAC) protocol for a wireless network. In an embodiment, the MAC protocol is specified by IEEE standard 802.15.3; however, embodiments are not necessarily limited to implementing IEEE 802.15.3.

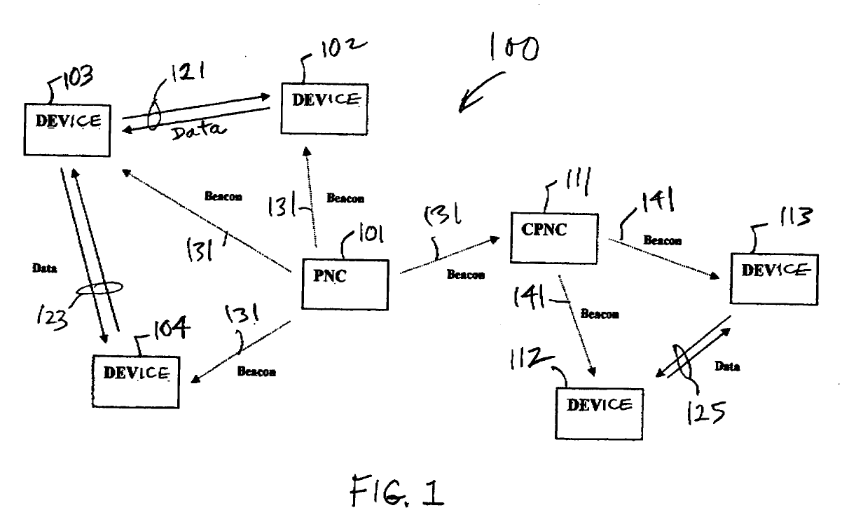

FIG. 1 illustrates a block diagram of a wireless personal area network (WPAN) 100, in accordance with an embodiment of the inventive subject matter. WPAN 100, which is also referred to herein as a “piconet”, comprises a plurality of nodes 101-104 and 111-113, each of which may include at least one processor and a processor-readable medium for implementing the inventive subject matter described herein.

As used herein, “processor” means any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit. More than one processor, which may be of identical or different types, may be present in a node 101-104 and 111-113.

The WPAN 100 may follow a master/slave paradigm, in which a network node serving as a master may be designated as a “network coordinator” or “piconet coordinator” (PNC) 101, while other nodes in the WPAN 100 may function as slaves and are designated as “member nodes” or simply as “devices” 102-104, 112, and 113. Also shown in FIG. 1 is a “child piconet coordinator” (CPNC) 111.

A PNC, such as PNC 101, manages time allocations of other network devices using a continuous (in time) stream of “superframes”. A superframe may contain, among other things, individual time slots assigned to network devices for communicating data. The functions of PNC 101 and CPNC 111 will be described in greater detail below.

Nodes within the piconet may communicate with one another over defined communications channels, such as channels 121, 123, and 125. For example, nodes 102 and 103 may communicate information over channel 121; nodes 103 and 104 may communicate over channel 123; and nodes 112 and 113 may communicate over channel 125.

The physical layer specification of IEEE 802.15.3 standard provides for more than one piconet communications channel to exist concurrently within the 2.4 Gigahertz (GHz) band of the IEEE 802.15.3 standard. This allows more than one piconet to operate independently within the same physical location.

An important function of PNC 101 is to establish the basic timing for the piconet. PNC 101 does this by, at different times (which may be periodic), broadcasting a beacon, such as beacon 131, which may be received by each of devices 102-104 and by CPNC 111. In an embodiment, beacon 131 may be a data packet. Beacon 131 may form part of a superframe.

The beacons 131 generated by PNC 101 define time allocations for the different devices to transmit data within the network. As described below, a beacon or beacon header designates the start of, and may occupy an initial portion of, each “superframe”. Each superframe may contain, among other things, individual time allocations to network devices for communicating information. The communicated information may be of any type, including application data and network control information.

At the time the beacon of a particular superframe is transmitted, the footprint or time slot allocation for that superframe is fixed. The IEEE 802.15.3 specification provides the PNC with some flexibility for managing superframes and individual time slot allocations. However, some piconet applications and device configurations that may be managed by a PNC have conflicting requirements on the PNC for how the available time within superframes should be managed, which limits this flexibility. For example, child and neighbor piconets (discussed further below), and pseudo-static time slot allocations, may require the length of the superframe to remain effectively fixed.

On the other hand, certain applications, such as those that exchange multi-media data, will benefit from reduced buffering, better link utilization, and possibly other network operational characteristics, if the PNC is allowed to dynamically (and even drastically) change the length of the superframe.

Current IEEE 802.15.3 defined capabilities do not allow the above-mentioned different application types to gracefully co-exist within a piconet, at least not without undue penalty to one or the other application. The inventive subject matter described herein, which in at least one embodiment comprises “micro-scheduling”, adds to IEEE 802.15.3 networks, as well as to other networks, the capability of dynamically managing time slots while also maintaining the length of superframes essentially fixed.

A piconet, such as WPAN 100 in FIG. 1, may be started in an ad hoc fashion by a device with the capability of performing the functions of a PNC, such as PNC 101. A device desiring to become a PNC finds an available channel that is not being used and begins broadcasting beacons. Other devices may then join the piconet by transmitting messages to the PNC using time slots that are identified by the beacon for that purpose.

If all available channels are busy, a device may start a dependent piconet that depends upon the PNC of another piconet (called a “parent piconet”) for its time allocation. Dependent piconets may come in at least two varieties: “child piconets” and “neighbor piconets”. The PNC of a child piconet is a member of the parent piconet, whereas the PNC of a neighbor piconet is not a member of the original piconet.

Still referring to FIG. 1, child piconet coordinator (CPNC) 111 may at different times (which may be periodic) broadcast beacons, such as beacon 141, which may be received by other network devices, such as devices 112 and 113. As mentioned above, a beacon broadcast by CPNC 111 may allocate time slots within a time slot allocated by a parent, such as PNC 100.

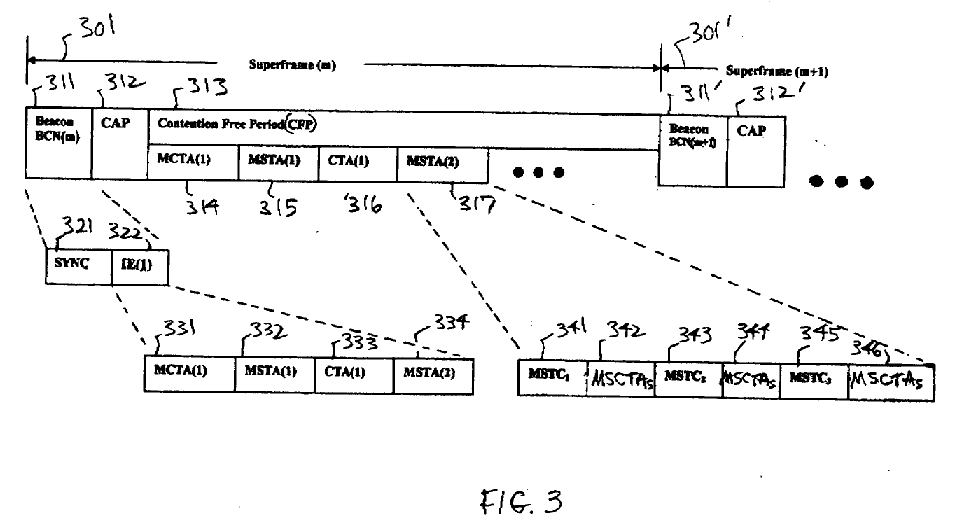

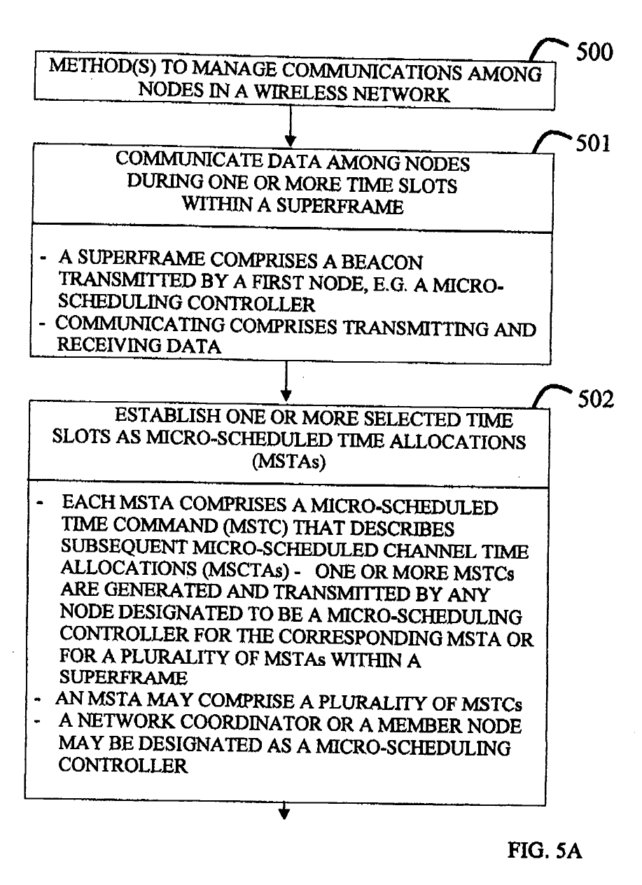

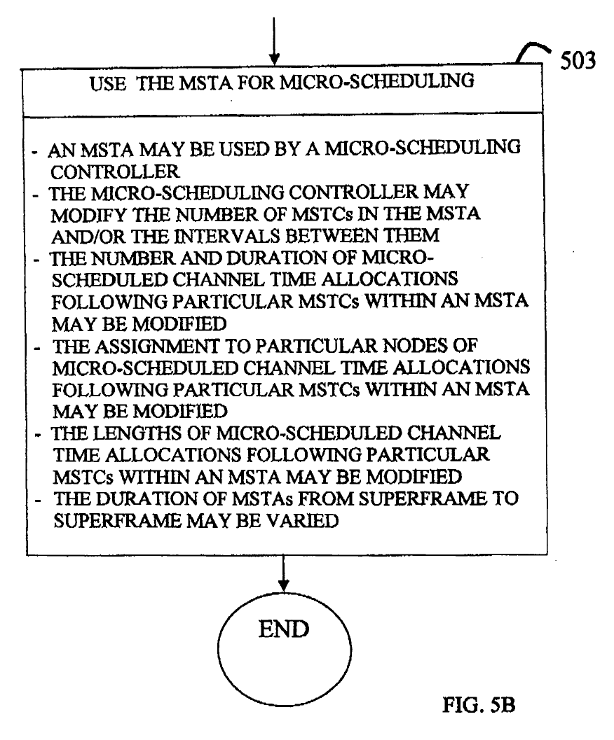

Embodiments of the invention may implement a capability referred to herein as “micro-scheduling”, which will be discussed in greater detail with respect to FIGS. 3, 5A, and 5B below. Micro-scheduling, as disclosed herein, is a mechanism by which flexible time scheduling of channel time may be provided to member nodes within a wireless personal area network (WPAN).

Micro-scheduling may be implemented within the framework of a MAC protocol such as that specified by IEEE 802.15.3 or otherwise. In an exemplary protocol, time is divided into discrete segments called “superframes”, which contain time slots used for data transmission between member nodes of the network. A beacon transmitted by one of the nodes may signify the beginning of each superframe and point to (i.e., identify) time slots contained within the superframe.

In the context of an IEEE 802.15.3 embodiment, the beacon may be transmitted by a node designated as the “network coordinator”, while in other embodiments beacons may be transmitted by one or more nodes in a distributed manner. The superframe may contain a plurality of time slots, each referred to as a “channel time allocation” (CTA), for use by designated nodes in transmitting data, including scheduling information.

One or more particular CTAs may be designated as a “micro-scheduled time slot” or “micro-scheduled time allocation” (MSTA), which is where micro-scheduling may occur within at least one embodiment. Each MSTA may begin with a “micro-scheduled time command” or, expressed more succinctly hereafter, a “micro-scheduled command” (MSTC). The MSTC is transmitted by a node designated to be the micro-scheduling controller for that MSTA. Different nodes (or alternatively the same node) may be designated as the micro-scheduling controller for different MSTAs. An MSTA may contain additional MSTCs within it. The MSTCs in essence act as mini-beacons that describe micro-scheduled channel time allocations (MSCTAs) allocated to particular nodes by a micro-scheduling controller.

The micro-scheduled channel time allocations (MSCTAs) within the MSTA are time segments during which the particular assigned nodes may transmit and receive data. The composition of a particular MSTA may be dynamically modified during the same MSTA by the micro-scheduling controller, several illustrative examples of which are discussed below regarding FIG. 3. Thus, scheduling information, such as, but not limited to, the intervals between MSTCs, the assignment of micro-scheduled channel time allocations to particular nodes, and the lengths of the micro-scheduled channel time allocations, may be dynamically changed as needed and/or or as requested by a micro-scheduling controller.

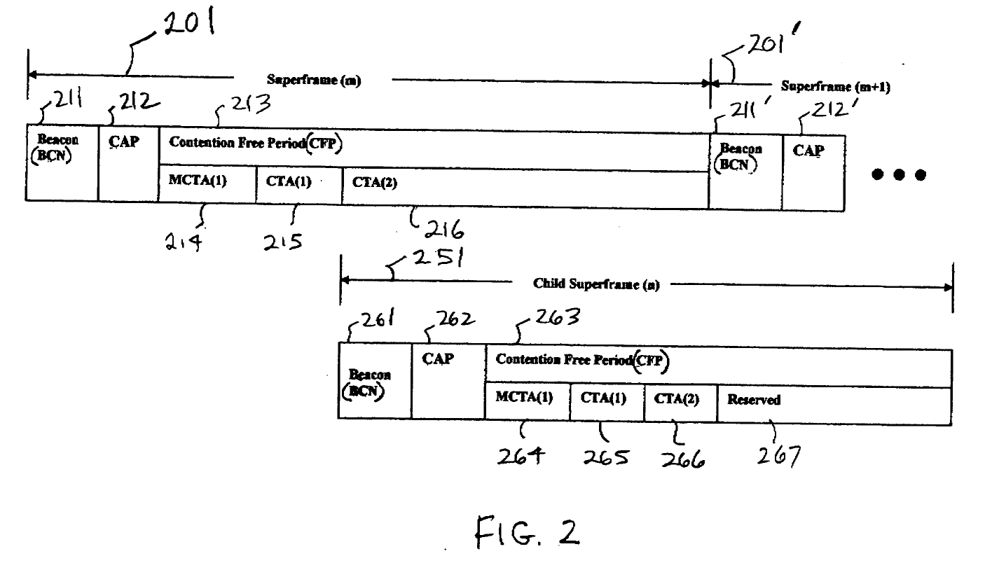

FIG. 2 illustrates a superframe 201 and a child superframe 251, in accordance with an embodiment of the inventive subject matter.

Beacons broadcast by a PNC (e.g. PNC 101, FIG. 1) may divide time into superframes, an exemplary structure of which is shown in FIG. 2. The superframe 201 may comprise three main parts. A first part is the beacon (BCN) 211, which allows devices to synchronize to a piconet and which contains information that identifies the piconet, the superframe duration, and the channel time allocations. The beacon 211 thus may contain descriptions of the time allocations for the entire superframe.

A second part of the superframe 201 is the contention access period (CAP) 212, which period may be used for communicating signaling or network control messages as well as small data transfers. Access to the CAP 212 may be based, for example, on CSMA/CA (Carrier Sense Multiple Access with Collision Avoidance) in an embodiment.

A third part of the superframe 201 is the contention free period (CFP) 213, which may be accessed by devices in a manner dictated by the PNC, based upon a TDMA (time division multiple access) communications protocol. The CFP 213 may be divided into time slots called channel time allocations (CTAs) 214-216, which may be used for data transfer by the member devices of the piconet. Particular CTAs may be used for commands transmitted to or from the PNC, which CTAs are designated herein as “management channel time slots” or “management channel time allocations” (MCTAs) 214. In certain cases, the CAP 212 may be replaced by the exclusive use of one or more MCTAs 214.

The CTAs 214-216 within the CFP 213 may be dynamic, or they may be pseudo-static. The position of dynamic CTAs within the superframe 201 may be modified by the PNC from superframe to superframe with appropriate annotation in the beacon header, while the position of a pseudo-static CTA may only be changed after the PNC notifies the affected device(s).

Superframe 201 is illustrated as being followed in time by a subsequent superframe 201′, which may in turn comprise a beacon 211′, a CAP 212′, and a CFP (not shown).

Similar to superframe 201, child superframe 251 may comprise a beacon 261, a CAP 262, and a CFP 263. The CFP 263 may comprise channel time allocations (CTAs) 264-266. CTA 264 may be a management channel time allocation (MCTA) 264. A portion 267 of CFP 263 may be designated as reserved.

Referring to both FIGS. 1 and 2, a parent PNC 101 may allocate a CTA 214-216 to a CPNC 111, during which time the CPNC 111 may broadcast its beacon 261 and allocate its own CAP 262 and CFP 263.

FIG. 3 illustrates a micro-scheduling capability implemented in a superframe, in accordance with an embodiment of the inventive subject matter. This figure illustrates how a micro-scheduling capability according to an embodiment of the inventive subject matter may be implemented within a superframe 301. Superframe 301 may be used within an IEEE 802.15.3 network, but it could also be used by a different type of network.

Before describing FIG. 3 in detail, an overview of micro-scheduling will first be presented with respect to an embodiment. In an exemplary implementation, micro-scheduling may operate in the following manner. A PNC allocates a guaranteed time slot (e.g., a CTA) and annotates it via information in the beacon header as a time slot during which micro-scheduling will occur. This particular time slot is called a “micro-scheduled time allocation” (MSTA). Micro-scheduling allows any device (including a PNC) to flexibly manage the time during a micro-scheduled time allocation. A device managing the time slots during a micro-scheduled time allocation is called a “micro-scheduling controller”. A micro-scheduled time allocation may include a micro-scheduled command (broadcast from a micro-scheduling controller) and its associated micro-scheduled channel time allocations (MSCTAs). A micro-scheduled command may be viewed essentially as a mini-beacon that describes time slot allocations for the current communication sequence. A micro-scheduling controller has flexibility for managing the composition of the one or more micro-scheduled channel time allocations.

Referring again to FIG. 3, a representative superframe 301 is followed by a subsequent superframe 301′. The PNC may broadcast a beacon BCN 311 at the start of superframe 301. Beacon 311 may contain, among other things, a synchronization parameter (SYNC) 321, which may point to (i.e., identify) the time position of the next beacon BCN 311′. Beacon 311 may also contain an information element IE(1) 322, which may comprise a channel time allocation list that may include a plurality of channel time allocation records 331-334.

Each channel time allocation record 331-334 may identify a respective channel time allocation (CTA) 314-317 within the CFP 313. For example, channel time allocation record MCTA(1) 331 may identify a management channel time allocation MCTA(1) 314. Channel time allocation record MSTA(1) 332 may identify a first micro-scheduled time allocation MSTA(1) 315. Channel time allocation record CTA(1) 333 may identify channel time allocation CTA(1) 315. And channel time allocation record MSTA(2) 334 may identify a second micro-scheduled time allocation MSTA(2) 317. The channel time allocation records 331-334 in IE(1) 322 thus annotate the CTAs 314-317 within the superframe and their time positions.

The beacon BCN 311 is followed by a contention access period (CAP) 312 and by a contention free period (CFP) 313 containing one or more channel time allocations (CTAs) 314-317. In the exemplary embodiment shown in FIG. 3, CTAs may include a management channel time allocation 314 designated MCTA(1), a first micro-scheduled time allocation 315 MSTA(1), a standard channel time allocation 316 designated CTA(1), and a second micro-scheduled time allocation 317 MSTA(2).

As described above, a micro-scheduled time allocation MSTA 315 is a special type of CTA, and it is where micro-scheduling takes place within an embodiment. Each MSTA may be managed by a designated micro-scheduling controller, which may be a device or the PNC. A superframe may contain a chain of micro-scheduled time allocations (MSTAs), each comprising one or more micro-scheduled commands (MSTCs) as well as corresponding micro-scheduled channel time allocations (MSCTAs) described by the MSTCs.

Each MSTA may contain a plurality of MSTCs. In FIG. 3, the contents of the second micro-scheduled time slot MSTA(2) 317 are shown as starting with an MSTC₁ 341 followed by its associated MSCTAs 342. The second micro-scheduled time slot MSTA(2) 317 may also contain additional MSTCs, for example those designated as MSTC₂ 343 and MSTC₃ 345, followed by their respective MSCTAs 344 and 346, respectively.

When an MSTA comprises an MSTC, the micro-scheduling controller may alter and manage the composition of the same MSTA during the time allocated to it by the PNC. As one example of dynamic management of the MSTA, a micro-scheduling controller may monitor the results of communications between the devices to which it has assigned MSCTAs during the MSTA, and it may modify the composition of the MSTA accordingly.

For example, during a given MSTA, the micro-scheduling controller may determine that a particular data transfer failed and should be retried in a subsequent time slot, e.g., following a subsequent MSTC. As another example, the micro-scheduling controller may determine that a particular data transfer succeeded, so that the data stream should be advanced in a subsequent time slot. During an MSTA, the micro-scheduling controller may also dynamically modify the number of MSTCs in the MSTA, the intervals between the MSTCs, the assignment of MSCTAs to particular devices, and the length of the individual MSCTAs. Other suitable modifications could also be made.

The micro-scheduling capabilities as described above may be incorporated into a medium access control (MAC) protocol for wireless networking that uses a superframe to divide time into discrete segments. The superframe includes a beacon transmitted by a node to signify the beginning of the superframe, and a plurality of time slots, each referred to as a channel time allocation (CTA), for use by designated nodes in transmitting data. The CTAs may be indexed by an information element (IE) contained in the beacon. One or more particular CTAs may be designated as a micro-scheduled time allocation (MSTA) and annotated as such within the beacon.

Each MSTA may begin with a micro-scheduled command (MSTC), transmitted by a node designated to be a micro-scheduling controller for that MSTA. The MSTC describes the micro-scheduled channel time allocations following the MSTC. The MSTA may also contain one or more additional MSTCs, followed by their respective micro-scheduled channel time allocations. As mentioned above, the number of MSTCs and the intervals between the MSTCs may be dynamically determined by the micro-scheduling controller during the MSTA. The micro-scheduled channel time allocations within the MSTA are defined time segments following an MSTC, during which assigned nodes may transmit and receive data. Thus, in various embodiments, the number of such micro-scheduled channel time allocations, the intervals between them, the assignments of the micro-scheduled channel time allocations to particular devices in a network, and/or the length of the micro-scheduled channel time allocations may be dynamically determined by the micro-scheduling controller.

In various embodiments, the inventive subject matter allows applications with conflicting scheduling constraints to gracefully concurrently exist. The micro-scheduling capability allows the convergence of different applications, some of which have significantly conflicting scheduling requirements, to peacefully and transparently co-exist. Platforms having this capability have potentially greater value in the marketplace.

In addition, whereas a PNC possibly may not possess appropriate or optimized scheduling algorithms, the inventive subject matter enables other network devices, in addition to a PNC, that may have specialized knowledge regarding a particular application, to micro-schedule that application's data flows.

Various other features and capabilities may also be incorporated. For example, in an embodiment, a node may be designated as the micro-scheduling controller for a plurality of MSTAs within a superframe. In another embodiment, a member node may request allocation of one or more MSTAs by messaging the network coordinator through a management time slot, and the member node may also request that itself, another member node, or the network coordinator be designated as the micro-scheduling controller. In yet another embodiment, the position within a superframe of the MSTAs and/or the duration of the MSTAs may be allowed to vary from superframe to superframe.

Upon reading and comprehending the content of this disclosure, one of ordinary skill in the art will understand the manner in which a software program can be launched from a computer-readable medium in a computer-based system to execute the functions defined in the software program. One of ordinary skill in the art will further understand the various programming languages that may be employed to create one or more software programs designed to implement and perform the methods disclosed herein. The programs may be structured in an object-orientated format using an object-oriented language such as Java or C++. Alternatively, the programs can be structured in a procedure-orientated format using a procedural language, such as assembly or C. The software components may communicate using any of a number of mechanisms well known to those skilled in the art, such as application program interfaces or interprocess communication techniques, including remote procedure calls. The teachings of various embodiments are not limited to any particular programming language or environment. Thus, other embodiments may be realized.

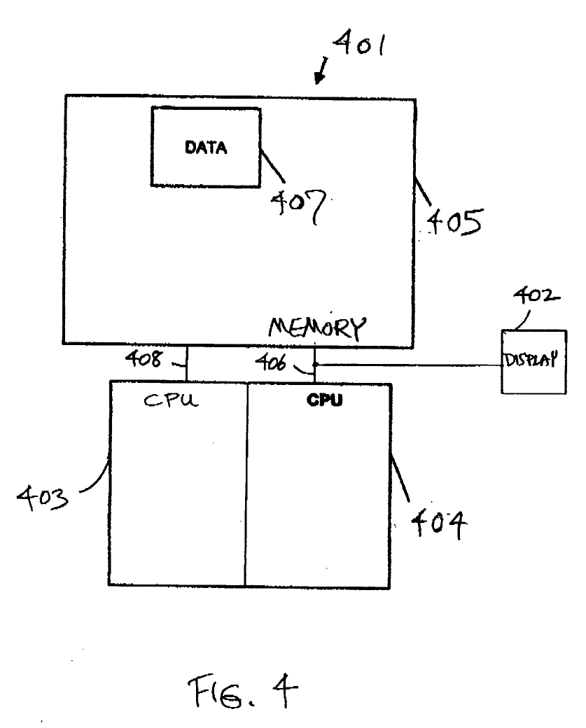

FIG. 4 is a block diagram of an article 401 according to various embodiments of the inventive subject matter. Article 401, according to various embodiments may comprise a computer, a memory system, a magnetic or optical disk, some other storage device, a suitable display 402, an integrated circuit, and/or any type of electronic device or system. Article 401 may include at least one processor 403 and/or 404 coupled via one or more busses 406 and 408 to a machine-accessible medium such as a memory 405 (e.g., a memory including an electrical, optical, or electromagnetic conductor) having associated information 407 (e.g., computer program instructions and/or data), which, when accessed, results in a machine (e.g., the processors 403 and/or 404) performing such actions as providing micro-scheduling and communicating data among nodes of a wireless network.

Other activities may include establishing one or more selected time slots as micro-scheduled time allocations (MSTAs), each having at least one micro-scheduled time command (MSTC) and associated micro-scheduled channel time allocations (MSCTAs). Further activities include establishing the number of such MSTCs, the number and duration of MSCTAs, and the assignments of MSCTAs to devices in a network by the micro-scheduling controller during the MSTA.

FIGS. 5A and 5B together constitute a flow diagram 500 illustrating several methods to manage communications among nodes in a wireless network, according to various embodiments of the inventive subject matter.

In 501, data is communicated among network nodes during one or more time slots within a superframe. A superframe comprises a beacon transmitted by a first node, such as a micro-scheduling controller. The superframe may begin with the beacon. Communicating comprises transmitting and receiving data.

In 502, one or more selected time slots are established as micro-scheduled time allocations (MSTAs). Each MSTA comprises a micro-scheduled time command (MSTC) that describes or defines the use of subsequent channel time through micro-scheduled channel time allocations (MSCTAs). The MSCTAs may follow the MSTC. One or more MSTCs may be generated and transmitted by any node designated to be a micro-scheduling controller for a particular MSTA. A node may also be designated a micro-scheduling controller for a plurality of MSTAs within a superframe. A network coordinator or another member node of the network may be designated as the micro-scheduling controller.

In 503, an MSTA may be used for micro-scheduling. An MSTA may be used, for example, by a micro-scheduling controller. A micro-scheduling controller may use the MSTA in any of a number of different ways, depending upon the type of network and its operational characteristics. Thus, a micro-scheduling controller may modify the number of MSTCs in the MSTA and/or the intervals between the MSTCs. A micro-scheduling controller may modify the number and duration of MSCTAs following particular MSTCs within an MSTA. A micro-scheduling controller may modify the assignment to particular nodes of MSCTAs following particular MSTCs within an MSTA. A micro-scheduling controller may modify the lengths of MSCTAs following particular MSTCs within an MSTA. The duration of MSTAs from superframe to superframe may also be modified by a micro-scheduling controller.

Although FIG. 5B shows the methods ending in 504, it will be understood that they may be continuously performed. It should be noted that the methods described herein do not necessarily have to be executed in the order described, or in any particular order. Moreover, various activities described with respect to the methods identified herein can be executed in serial or parallel fashion.

Although the inventive subject matter has been described in conjunction with the foregoing specific embodiments, many alternatives, variations, and modifications will be apparent to those of ordinary skill in the art. Such alternatives, variations, and modifications are intended to fall within the scope of the following appended claims.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. Individual claims may encompass multiple embodiments of the inventive subject matter

What is claimed is:

1. A method comprising:
communicating data among a plurality of nodes in a wireless network during one or more time slots within a superframe; and
establishing one or more selected time slots as micro-scheduled time allocations, each micro-scheduled time allocation comprising a micro-scheduled command that describes one or more channel time allocations associated with the micro-scheduled command.

2. The method of claim 1, further comprising:
establishing a micro-scheduled time allocation during the superframe.

3. The method of claim 1, further comprising:
establishing a duration of a subsequent micro-scheduled time allocation during a current micro-scheduled time allocation

4. The method of claim 2, wherein the micro-scheduled time allocation is established by a selected node in the network.

5. The method of claim 1, wherein communicating comprises transmitting and receiving data.

6. The method of claim 1, wherein each channel time allocation defines a time slot during which a node may communicate.

7. The method of claim 1, wherein a superframe begins with a beacon transmitted by a first node of the plurality of nodes.

8. The method of claim 1, wherein each micro-scheduled time allocation begins with a micro-scheduled command.

9. The method of claim 1, wherein the channel time allocations follow the micro-scheduled command.

10. The method of claim 1, wherein a micro-scheduled time allocation comprises a plurality of micro-scheduled commands.

11. The method of claim 10 further comprising modifying the number of channel time allocations following particular micro-scheduled commands within a micro-scheduled time allocation during the micro-scheduled time allocation.

12. The method of claim 10 further comprising modifying the assignment to particular nodes of channel time allocations following particular micro-scheduled commands within a micro-scheduled time allocation during the micro-scheduled time allocation.

13. The method of claim 10 further comprising modifying the lengths of channel time allocations following particular micro-scheduled commands within a micro-scheduled time allocation during the micro-scheduled time allocation.

14. The method of claim 10 further comprising varying the duration of micro-scheduled time allocations from superframe to superframe.

15. The method of claim 1, wherein a micro-scheduled command is transmitted by a node designated to be a micro-scheduling controller for the corresponding micro-scheduled time allocation.

16. The method of claim 15, wherein each micro-scheduled time allocation comprises a plurality of micro-scheduled commands, and wherein the micro-scheduling controller modifies the number of micro-scheduled commands in the micro-scheduled time allocation.

17. The method of claim 15, wherein each micro-scheduled time allocation comprises a plurality of micro-scheduled commands, and wherein the micro-scheduling controller modifies intervals between micro-scheduled commands in the micro-scheduled time allocation.

18. The method of claim 15, wherein each micro-scheduled time allocation comprises a plurality of channel time allocations assigned to different nodes, and wherein the micro-scheduling controller modifies the assignment of channel time allocations to particular nodes.

19. The method of claim 15, wherein each micro-scheduled time allocation comprises a plurality of channel time allocations assigned to different nodes, and wherein the micro-scheduling controller modifies the duration of channel time allocations.

20. The method of claim 1, wherein establishing one or more selected time slots is performed by a micro-scheduling controller.

21. The method of claim 20 further comprising designating a node as a micro-scheduling controller for a plurality of micro-scheduled time allocations within a superframe.

22. The method of claim 20, wherein either a network coordinator or a member node may be designated as a micro-scheduling controller.

23. A medium access protocol for a wireless network, comprising:
a superframe to divide time into discrete segments, wherein the superframe has an initial portion comprising a beacon transmitted by a node of the network;
wherein the superframe includes a plurality of time allocations for use by designated nodes in communicating data;
wherein the time allocations are identified by information contained in the beacon;
wherein one or more selected time allocations may be designated as a micro-scheduled time allocation and identified as such in the beacon, each micro-scheduled time allocation including a micro-scheduled command, which is transmitted by a node designated to be a micro-scheduling controller for the corresponding micro-scheduled time allocation;
wherein the micro-scheduled command describes micro-scheduled channel time allocations associated with the micro-scheduled command within the same micro-scheduled time allocation; and
wherein a micro-scheduled time allocation is modified by the micro-scheduling controller during the micro-scheduled time allocation.

24. The protocol of claim 23, wherein a selected micro-scheduled time allocation may contain a plurality of micro-scheduled commands each of which describes micro-scheduled channel time allocations that follow the micro-scheduled command and that are assigned by the micro-scheduling controller to be used for data transfer by selected nodes of the network

25. The protocol of claim 24, wherein the assignment to selected nodes of micro-scheduled channel time allocations may be modified by the micro-scheduling controller during the micro-scheduled time allocation.

26. The protocol of claim 24, wherein the lengths of micro-scheduled channel time allocations may be modified by the micro-scheduling controller during the micro-scheduled time allocation.

27. The protocol of claim 23, wherein one of a plurality of nodes acts as a network coordinator for the remaining member nodes of the network, and wherein beacons are transmitted by the network coordinator.

28. The protocol of claim 27, wherein either the network coordinator or a member node may be designated as a micro-scheduling controller.

29. The protocol of claim 23, wherein beacons are transmitted by a plurality of nodes.

30. The protocol of claim 23, wherein a node may be designated as the micro-scheduling controller for a plurality of micro-scheduled time allocations within a superframe.

31. The protocol of claim 23, wherein the number of micro-scheduled commands may be modified by the micro-scheduling controller during the micro-scheduled time allocation.

32. The protocol of claim 23, wherein the interval between micro-scheduled commands may be modified by the micro-scheduling controller during the micro-scheduled time allocation.

33. The protocol of claim 23, wherein the number of micro-scheduled channel time allocations following selected micro-scheduled commands within a micro-scheduled time allocation may be modified by the micro-scheduling controller during the micro-scheduled time allocation.

34. The protocol of claim 23, wherein the duration of micro-scheduled time allocations may vary from superframe to superframe.

35. An article comprising a machine-accessible medium having associated information, wherein the information, when accessed, results in a machine performing:
communicating data among a plurality of nodes in a wireless network during one or more time slots within a superframe; and
establishing one or more selected time slots as micro-scheduled time allocations, each micro-scheduled time allocation comprising a micro-scheduled command that describes micro-scheduled channel time allocations associated with the micro-scheduled command.

36. The article of claim 35, wherein the information, when accessed, results in the machine performing:
establishing a micro-scheduled time allocation during the superframe.

37. The article of claim 35, wherein the information, when accessed, results in the machine performing:
designating a node as a micro-scheduling controller for a plurality of micro-scheduled time allocations within a superframe.

38. An integrated circuit comprising at least one processor to access a a processor-accessible medium having associated information, wherein the information, when accessed, results in the at least one processor performing:
communicating data among a plurality of nodes in a wireless network during one or more time slots within a superframe; and
establishing one or more selected time slots as micro-scheduled time allocations, each micro-scheduled time allocation comprising a micro-scheduled command that describes micro-scheduled channel time allocations associated with the micro-scheduled command.

39. The integrated circuit of claim 38, wherein the at least one processor is further to perform:
establishing a micro-scheduled time allocation during the superframe.

40. The integrated circuit of claim 38, wherein the at least one processor is further to perform:
designating a node as a micro-scheduling controller for a plurality of micro-scheduled time allocations within a superframe.

41. A system comprising:
a bus coupling elements of the system;
at least one processor coupled to the bus;
a display coupled to the bus;
a memory coupled to the bus to store instructions, the at least one processor to execute instructions comprising the operations of:
communicating data between selected nodes in a wireless network during one or more time slots within a superframe; and
establishing one or more selected time slots as micro-scheduled time allocations, each micro-scheduled time allocation comprising a micro-scheduled command that describes micro-scheduled channel time allocations associated with the micro-scheduled command.

42. The system of claim 41, wherein the at least one processor is further to execute instructions comprising the operation of:
establishing a micro-scheduled time allocation during the superframe.

43. The system of claim 41, wherein the at least one processor is further to execute instructions comprising the operation of:
designating a node as a micro-scheduling controller for a plurality of micro-scheduled time allocations within a superframe.
